(19) United States
(12) Patent Application Publication
(10) Pub. No.: US 2025/0355818 A1
(43) Pub. Date: Nov. 20, 2025

(54) SYSTEM AND METHOD FOR BUILDING A CONFIGURATION TABLE AND UPDATING A TARGET DEVICE

(71) Applicant: Microsemi SoC Corp., Chandler, AZ (US)

(72) Inventor: Nader Misri, San Juan Capistrano, CA (US)

(73) Assignee: Microsemi SoC Corp., Chandler, AZ (US)

(21) Appl. No.: 18/800,965

(22) Filed: Aug. 12, 2024

Related U.S. Application Data
(60) Provisional application No. 63/649,599, filed on May 20, 2024.

(51) Int. Cl. G06F 13/16

(52) U.S. Cl. CPC G06F 13/1694; G06F 13/1689

(57) ABSTRACT

System and method for updating a target device. Firmware information associated with the target device may be detected. A GUI including actionable items may be presented on a display. User selections for the actionable items may be received. A configuration table for the target device may be built based on the user selections. The target device may be updated based on the configuration table and the firmware information.

### CROSS-REFERENCE TO RELATED APPLICATIONS

The current patent application claims the benefit under 35 U.S.C. § 119 (e) of the priority date of U.S. Provisional Application Ser. No. 63/649,599; titled “SYSTEM TO ENABLE GENERIC SPI FLASH MEMORY PROGRAMMING SUPPORT”; and filed May 20, 2024. The Provisional Application is hereby incorporated by reference, in its entirety, into the current patent application.

### TECHNICAL FIELD

Various examples of the present disclosure relate to systems and methods for building a configuration table and updating a target device based on the configuration table where, in one or more examples, the target device is updated without updating firmware code of an electronic device connected to the target device.

### BACKGROUND

External memory devices, such as serial peripheral interface (SPI) flash memory devices, are commonly implemented in connection with electronic devices such as field programmable gate arrays (FPGAs). Various electronic devices may include different firmware code from different vendors or manufacturers that may only support certain external memory devices. In many instances, the firmware code may be written to a read-only memory (ROM) and may not be programmed to support new electronic devices. Consequently, the firmware of the electronic devices may not be updated to support new external memory devices.

This background discussion is intended to provide information related to the present disclosure which is not necessarily prior art.

### SUMMARY OF THE INVENTION

According to various examples of the present disclosure, a non-transitory computer readable medium may be provided with instructions stored thereon that, when executed by one or more processors, cause the one or more processors to perform the following operations: detecting firmware information for a target device; presenting, on a display, a graphical user interface (GUI) including actionable items; receiving user selections for the actionable items; building a configuration table for the target device based on the user selections; and updating the target device based on the configuration table and the firmware information.

According to various examples of the present disclosure, a computer implemented method is provided. Firmware information associated with a target device may be detected. A GUI including actionable items may be presented on a display. User selections for the actionable items may be received. A configuration table for the target device may be built based on the user selections. The target device may be updated based on the configuration table and the firmware information.

According to various examples of the present disclosure, a system is provided. The system includes a target device and one or more computing devices. The one or more computing devices may include a memory and one or more processors. The memory may include instructions stored thereon that, when executed by the one or more processors, cause the one or more processors to perform the following operations: detecting firmware information for the target device; presenting, on a display, a graphical user interface (GUI) including actionable items; receiving user selections for the actionable items; building a configuration table for the target device based on the user selections; and updating the target device based on the configuration table and the firmware information.

### BRIEF DESCRIPTION OF THE DRAWINGS

FIG. 1 illustrates an example system including a client application for updating a target device;

FIG. 2 illustrates an example client computing device configured to execute the client application of FIG. 1;

FIG. 3 illustrates an example graphical user interface (GUI) displaying a constant data block of a configuration table of the client application of FIG. 1;

FIG. 4 illustrates an example GUI displaying an erase memory map of a configuration table of the client application of FIG. 1;

FIG. 5 illustrates an example GUI displaying initialization records of a configuration table of the client application of FIG. 1;

FIG. 6 illustrates an example GUI displaying pre-erase records of a configuration table of the client application of FIG. 1;

FIG. 7 illustrates an example GUI displaying post-erase records of a configuration table of the client application of FIG. 1;

FIG. 8 illustrates an example GUI displaying pre-program records of a configuration table of the client application of FIG. 1;

FIG. 9 illustrates an example GUI displaying post-program records of a configuration table of the client application of FIG. 1;

FIG. 10 illustrates an example GUI displaying termination records of a configuration table of the client application of FIG. 1;

FIG. 11 illustrates an example GUI displaying termination records and output information of a configuration table of the client application of FIG. 1; and

FIG. 12 illustrates an example method for reprogramming the target device of FIG. 1.

Unless otherwise indicated, the figures provided herein are meant to illustrate features of examples of this disclosure. These features are believed to be applicable in a wide variety of systems comprising one or more examples of this disclosure. As such, the figures are not meant to include all conventional features known by those of ordinary skill in the art to be required for the practice of the examples disclosed herein.

### DETAILED DESCRIPTION

In the following detailed description, reference is made to the accompanying drawings, which form a part hereof and in which are shown, by way of illustration, specific examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example or this disclosure to the specified components, operations, features, functions, or the like.

It will be readily understood that the components of the examples as generally described herein and illustrated in the drawings could be arranged and designed in a wide variety of different configurations. Thus, the following description of various examples is not intended to limit the scope of the present disclosure but is merely representative of various examples.

Various examples of the present disclosure relate to systems and methods for building a configuration table and updating a target device based on the configuration table. In various examples of the present example, the target device may be updated without updating firmware code of an electronic device connected to the target device. Various examples of the present disclosure relate to a firmware software program and a client application including a configuration table to enable generic programming support for serial peripheral interface (SPI) flash memories.

In various examples, a client computing device may include a client application for updating a target device. The target device may be electrically connected to an electronic device. The electronic device may include firmware code. The client computing device may establish a connection with the electronic device and the target device over a network. The client device may detect firmware information of the electronic device and the target device. The client application may render a graphical user interface (GUI) on a display of the client computing device. The GUI may display a configuration table having actionable items. A user may select the actionable items to build a configuration table for the target device. The configuration table may be built based on the user selection of the actionable items and on the firmware information of the target device. The configuration table may be sent to the target device over a communication network. The target device may be updated using the configuration table.

### Exemplary System

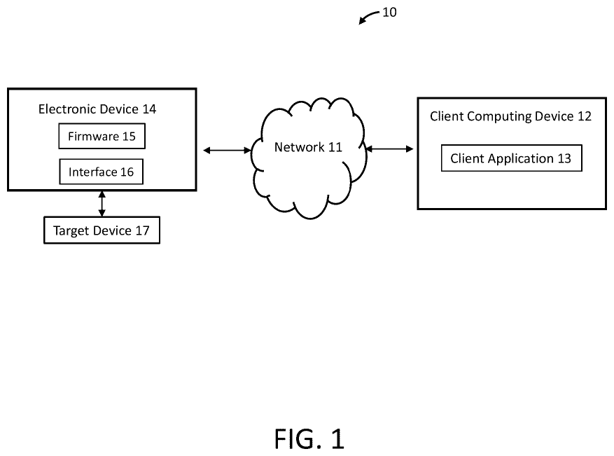

FIG. 1 illustrates a system 10 including a client application 13 for updating a target device 17. The system 10 includes an electronic device 14, a communications network 11, a client computing device 12, and the target device 17. In various examples, the electronic device 14 may be a microcontroller, a field-programmable gate array (FPGA), a field-programmable system level integrated circuit (FPSLIC), or a programmable logic device (PLD), a television, a printer, a computer, a modem, a Bluetooth device, an internet of things (IoT) device, and a media player, without limitation. In various examples, the communications network 11 may be a wired or wireless communications link, such as a Joint Test Action Group (JTAG) link, an SPI link, or an Ethernet link, without limitation.

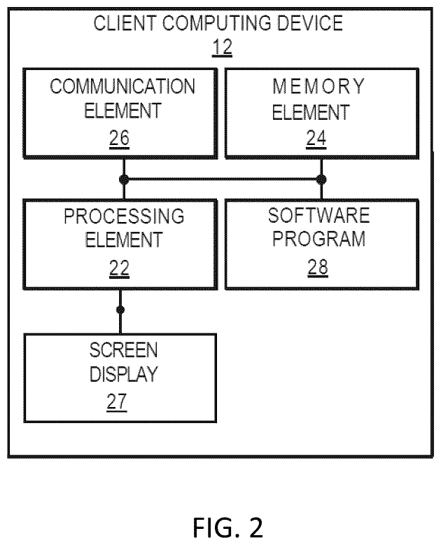

FIG. 2 illustrates an example client computing device 12 configured to execute the client application 13 of FIG. 1. The client computing device 12 may include one or more tablet computers, laptop computers, desktop computers, workstation computers, smart phones, smart watches, and the like. In one or more examples, the client computing device 12 may comprise server(s).

The client computing device 12 may include a processing element 22, a memory element 24, and circuitry capable of wired and/or wireless communication with the communication network 11, including, for example, a transceiver or communication element 26. The communication element 26 may include a JTAG interface, an ethernet interface, or an SPI interface, without limitation. The client computing device 12 may additionally include a screen display 27, which may comprise a user interface of the client computing device 12. The display 27 may include video devices of any of the following types: plasma, standard or ultra-high-definition light-emitting diode (LED), organic LED (OLED), quantum dot LED (QLED), Light Emitting Polymer (LEP) or Polymer LED (PLED), liquid crystal display (LCD), thin film transistor (TFT) LCD, LED side-lit or back-lit LCD, or the like, or combinations thereof. The display 27 may possess a square or a rectangular aspect ratio and may be viewed in either a landscape or a portrait mode. In various embodiments, the display 27 may also include a touch screen occupying all or part of the screen. In various examples, the GUI of the client application 13 may be rendered on the display 27.

Further, the client computing device 12 may include a software application or program 28 configured with instructions for performing and/or enabling performance of at least some of the steps set forth herein. In various examples, the software program 28 comprises instructions respectively stored on computer-readable media of a memory element 24. The software application 28 may correspond to the client application 13 described in reference to FIG. 1.

The communication element 26 generally allows communication between the client computing device 12 and the communication network 11. The communication element 26 may include one or more signal or data transmitting and receiving circuits, such as antennas, amplifiers, filters, mixers, oscillators, Ethernet interfaces, digital signal processors (DSPs), and the like. The communication element 26 may establish communication wirelessly by utilizing radio frequency (RF) signals and data that complies with communication standards such as cellular 2G, 3G, 4G or 5G, Institute of Electrical and Electronics Engineers (IEEE) 802.11 standard such as WiFi, IEEE 802.16 standard such as WiMAX, Bluetooth™, or combinations thereof. In addition, the communication element 26 may utilize communication standards such as ANT, ANT+, Bluetooth™ low energy (BLE), the industrial, scientific, and medical (ISM) band at 2.4 gigahertz (GHz), or the like. The communication element 26 may establish communication through connectors or couplers that receive metal conductor wires or cables, like Cat 6 or coax cable, which are compatible with networking technologies such as Ethernet. In various examples, the communication element 26 may also couple with optical fiber cables and may include one or more JTAG interfaces, Ethernet interfaces, or SPI interfaces, without limitation. The communication element 26 may be in communication with the processing element 22 and the memory element 24.

The memory element 24 may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory element 24 may be embedded in, or packaged in the same package as, the processing element 22. The memory element 24 may include, or may constitute, a “computer-readable medium.” The memory elements 24 may store the instructions, code, code segments, software, firmware, programs, applications, apps, services, daemons, or the like that are executed by the processing element 22. In an embodiment, the memory element 24 respectively store the software applications/program 28. The memory element 24 may also store settings, data, documents, sound files, photographs, movies, images, databases, and the like.

The processing element 22 may include electronic hardware components such as processors. The processing element 22 may include digital processing unit(s). The processing element 22 may include one or more microprocessors (single-core and multi-core), microcontrollers, digital signal processors (DSPs), field-programmable gate arrays (FPGAs), analog, or digital application-specific integrated circuits (ASICs), or the like, or combinations thereof, without limitation. The processing element 22 may generally execute, process, or run instructions, code, code segments, software, firmware, programs, applications, apps, processes, services, daemons, or the like. For instance, the processing element 22 may respectively execute the software applications/program 28. The processing element 22 may also include hardware components such as finite-state machines, sequential and combinational logic, and other electronic circuits that can perform the functions necessary for the operation of various examples of the present disclosure. The processing element 22 may be in communication with the other electronic components through serial or parallel links that include universal busses, address busses, data busses, control lines, and the like.

As noted above, the client computing device 12 may include memory element 24 and processing element 22 (shown in FIG. 2). The memory element 24 may store the client application 13 and include instructions for executing the client application 13. The one or more processors 22 may access the instructions stored in the memory 24 and execute the client application 13. The client application 13 may instruct the client computing device 12 to update the target device 17 over the communications network 11.

The communication network 11 generally allows communication between the client computing device 12 and one or more reprogrammable devices, for example in conjunction with reprogramming the electronic device 14 or the target device 17. The communication network 11 may include the Internet, Ethernet networks, cellular communication networks, local area networks, metro area networks, wide area networks, cloud networks, plain old telephone service (POTS) networks, and the like, or combinations thereof. The communication network 11 may be wired, wireless, or combinations thereof and may include components such as modems, gateways, switches, routers, hubs, access points, repeaters, towers, and the like. The client computing device 12 may, for example, connect to the communication network 11 either through wires, such as electrical cables or fiber optic cables, or wirelessly, such as RF communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, or combinations thereof.

In various examples, the target device 17 may be a serial peripheral interface (SPI) flash memory. The target device 17 may be electrically connected to the interface 16. The target device 17 may communicate with the electronic device 14 through the interface 16. In various examples, the interface may be an SPI interface, without limitation. The target device 17 may store application software to be executed by the electronic device 14. The target device 17 may store data for the electronic device 14. In various examples, the target device 17 may be external to the programmable device 14. In various examples, the target device 17 may be integrated into the electronic device 14. In various examples, the target device 17 and the electronic device 14 may be housed within distinct and separate housings and may be remote from one another.

In various examples, the electronic device 14 may include firmware code 15 and an interface 16. The firmware code 15 may be written to a read-only memory and may be specific to one or more vendors or manufacturers of the electronic device 14. The interface 16 may be a communication interface for communicating with the target device 17. The electronic device 14 may send data to the target device 17. The target device 17 may store the data. The target device 17 may send data and commands to the electronic device 14. The electronic device 14 may execute the commands. The electronic device 14 may receive configuration table(s) over the communication network 11. The data and information of the configuration tables, which may or may not be transmitted in the format of the configuration tables themselves, may be received from the client computing device 12. The configuration table data and information may enable the target device 17 to be reprogrammed without modifying the firmware code 15 of the electronic device 14.

The electronic device 14 may communicate with the target device 17 through the interface 16. In various examples, the interface 16 may be a wired or wireless interface. The interface 16 may use one or more communication protocols, such as cellular 2G, 3G, 4G or 5G, Institute of Electrical and Electronics Engineers (IEEE) 802.11 standard such as WiFi, IEEE 802.16 standard such as WiMAX, Bluetooth™, or combinations thereof. In addition, the interface 16 may utilize communication standards such as ANT, ANT+, Bluetooth™ low energy (BLE), the industrial, scientific, and medical (ISM) band at 2.4 gigahertz (GHz), or the like. The interface 16 may establish communication through connectors or couplers that receive metal conductor wires or cables, like Cat 6 or coax cable, which are compatible with networking technologies such as Ethernet. In various examples, the interface 16 may also couple with optical fiber cables and may include one or more JTAG interfaces, Ethernet interfaces, or SPI interfaces, without limitation.

During an initial setup, the target device 17 may be connected to the interface 16. In an example, the target device 17 may be a replacement SPI flash memory device to be used with the electronic device 14. In this example, the target device may be an FPGA, without limitation. The electronic device 14 may detect connection of the target device 17 to the interface 16. In various examples, the firmware code 15 may not be configured to communicate with the target device 17. When the firmware code 15 cannot communicate with the target device 17, the electronic device 14 may not execute program applications stored on the target device, write data to the target device 17, or read program data from the target device 17. Additionally, the firmware code 15 may not be able to be updated to communicate with the target device 17. The electronic device 14 may read device information from the target device 17. The device information may include an identifier (ID) of the target device. The electronic device 14 may communicate the device information to the client application 13 of the client computing device 12 over the communication network 11. The client application 13 may generate a configuration table for the target device 17 based on a plurality of user selections and the ID of the target device 17. The client computing device 12 may send the configuration table to the electronic device 14 over the communications network 11. The firmware code 15 may parse the configuration table. The firmware code 15 may determine whether the configuration table is valid. If the configuration table is valid, the electronic device 14 will update the target device 17 using the configuration table. After the target device 17 is updated, the firmware code 15 may be able to communicate with the target device 17.

The client computing device 12 may execute the client application 13 to build configuration table(s) for updating the target device 17. The configuration tables or the data embodied thereby may be sent by the client computing device 12 to the target device 17 over the communications network 11. The configuration tables may be generated and populated by the client application 13 based on user-defined parameters and device firmware information of the target device 17 and the electronic device 14. The configuration tables may include device parameters, specifications, commands, and instructions for reprogramming the target device. In various examples, the configuration tables may include specific information for the target device 17 including an ID code value, density, erase sector sizes, command opcodes, and memory maps, without limitation. The configuration tables may additionally include specific command sequences for instructing the target device 17 to perform tasks including device initialization, pre/post erase, pre/post program, and post action operations.

The instructions included in the configuration tables may include one or more of an erase operation, a programming operating, a verification operation, a read operation, a blank check operation, and a securing operation. The erase operation may include instructions for erasing at least a portion of data stored on the target device 17. The erase operation may additionally include passing action code to the target device 17. The programming and verification operations may include loading a buffer with valid data and instructing the electronic device 14 to pass the action code to the target device 17. The read operation may include reading data stored in the target device 17. The blank check operation may include checking for a blank state of the target device 17 that is specified in the configuration table. The securing operation may include checking security parameters of the target device 17.

### Graphical User Interface (GUI)

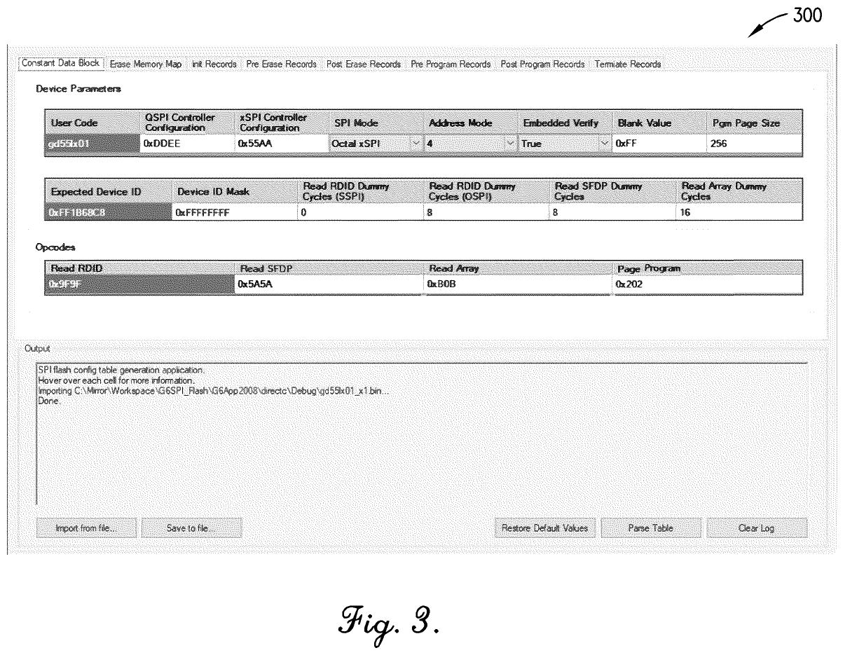

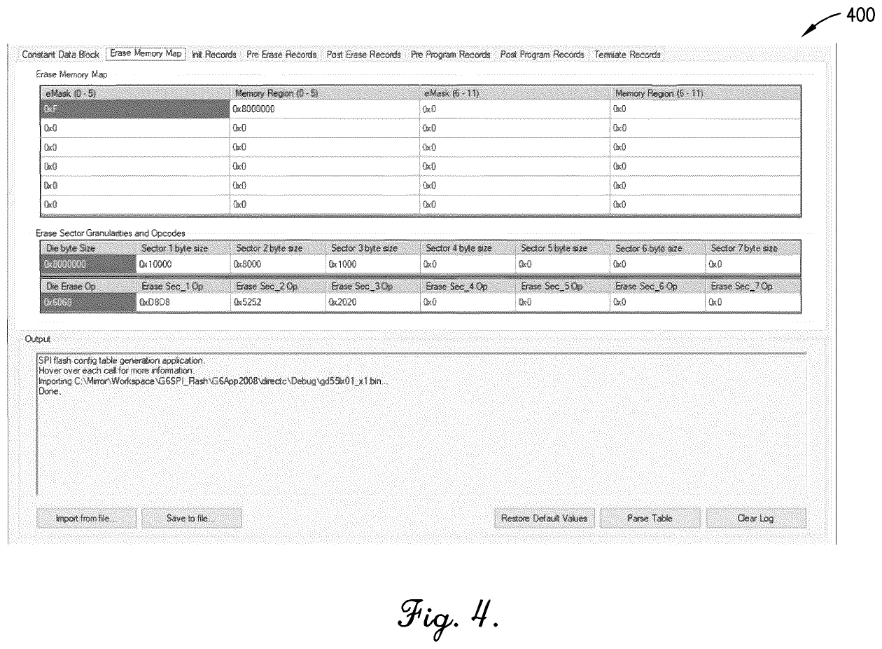

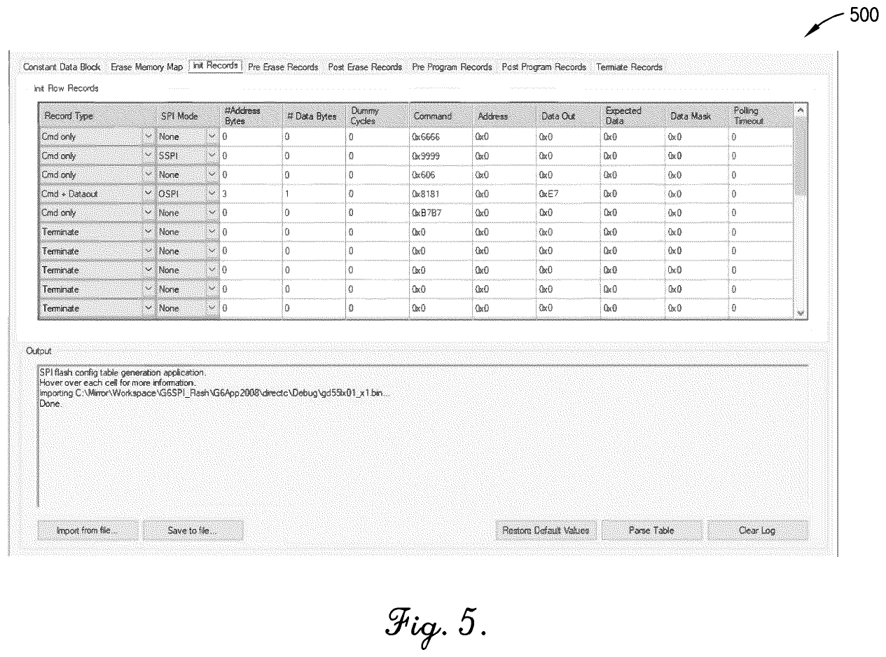

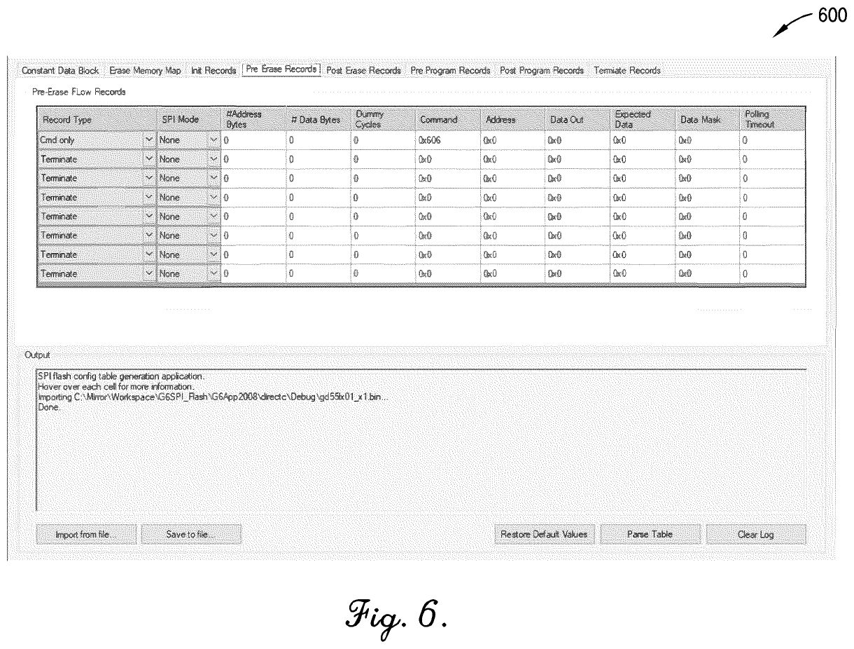

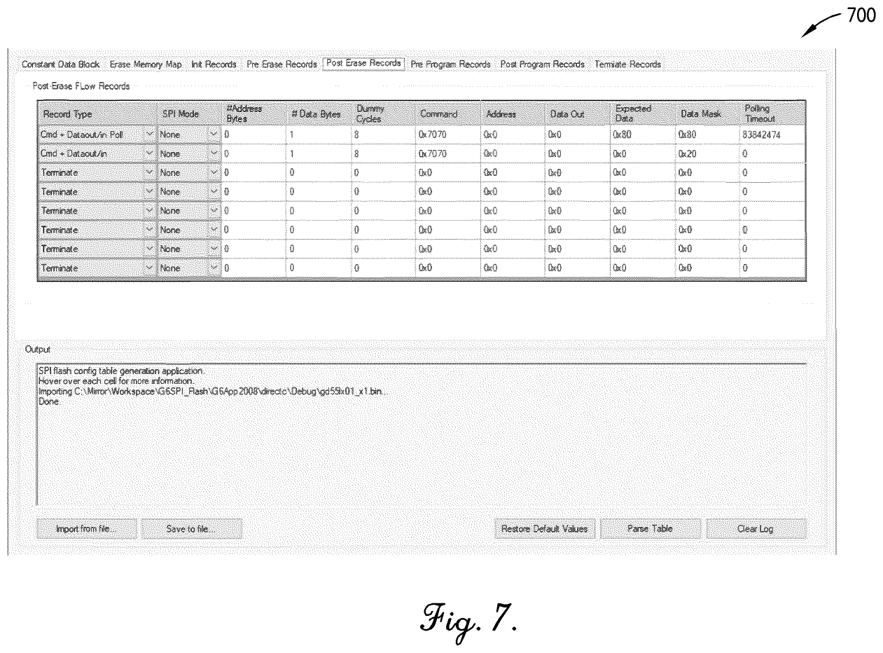

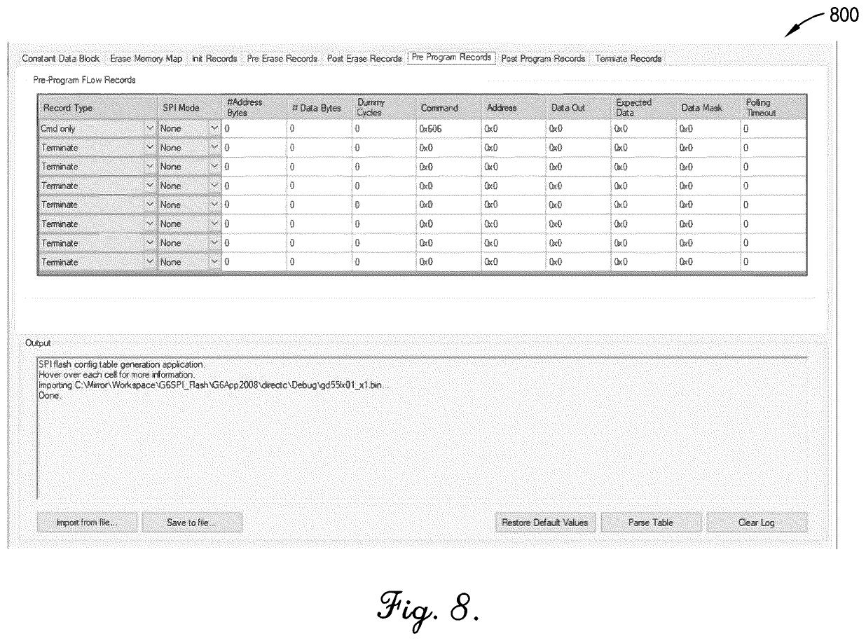

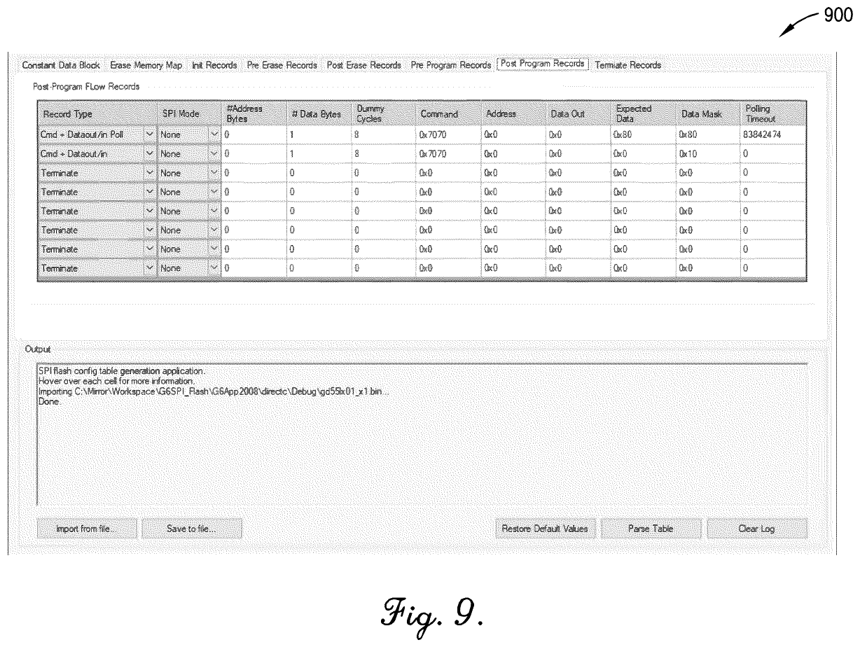

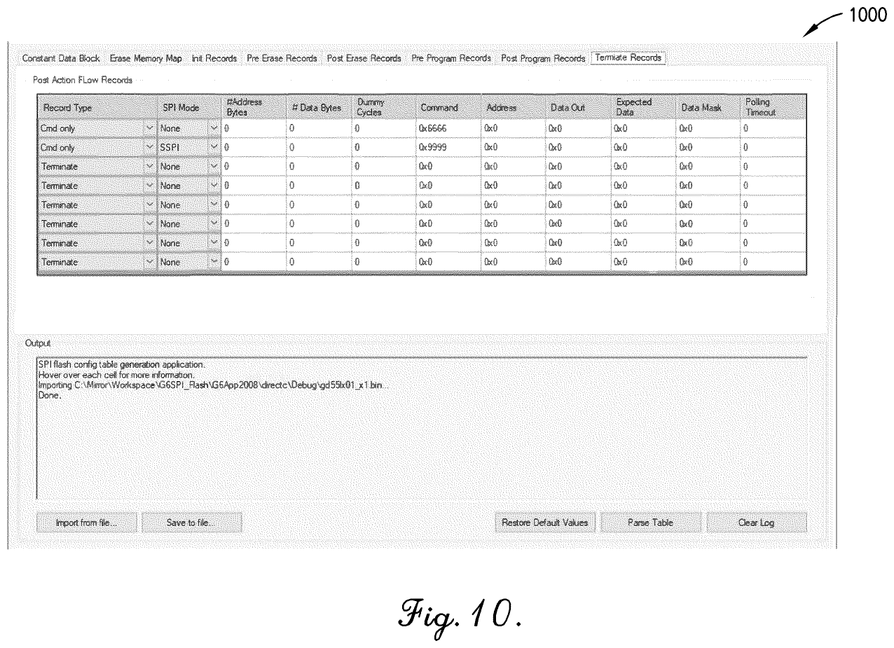

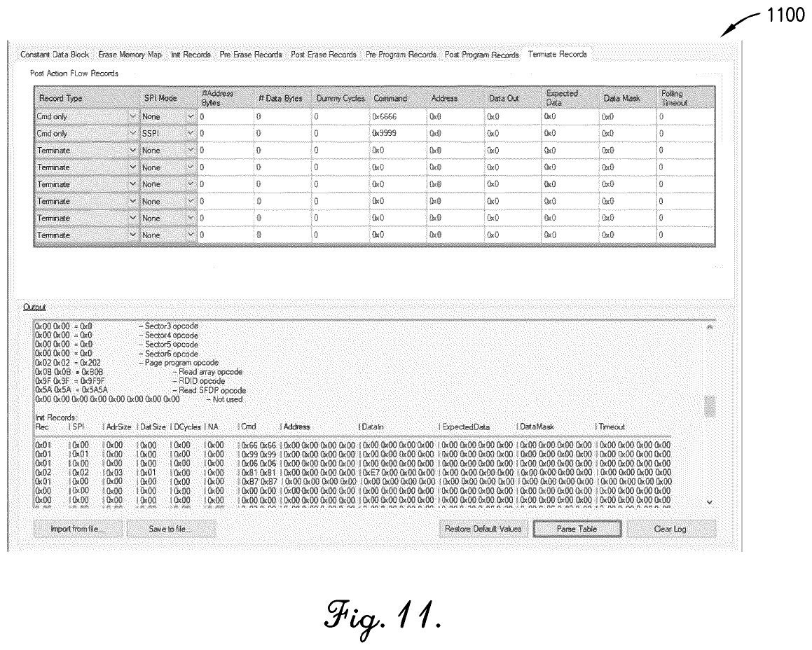

FIGS. 3-11 illustrate various GUI screens as displayed on a client computing device 12. The GUI may be rendered by the client application 13 on the display 27 of the client computing device 12. The various GUI screens may include actionable items corresponding to user-selectable portions of the configuration tables. The actionable items may be selected by a user for building the configuration tables. The actionable items may include device parameters (FIG. 3), opcodes (FIG. 3), an erase memory map (FIG. 4), erase sector granularities and opcodes (FIG. 4), initialization flow records (FIG. 5), pre-erase flow records (FIG. 6), post-erase flow records (FIG. 7), pre-program flow records (FIG. 8), post-program flow records (FIG. 9), and post action flow records (FIG. 10 and FIG. 11).

The actionable items may include various fields indicating information for the target device 17 to be entered by the user. Referring to FIG. 3, various fields for the device parameters may include a user code, a controller configuration, an SPI mode, an address mode, an embedded verification a blank value, a programming page size, an expected device identifier (ID), a number of read ID dummy cycles, a number of read serial flash discoverable parameter (SFDP) dummy cycles, and a number of read array dummy cycles. Various fields for the opcodes include read ID, read SFDP, read array, and page program.

Referring to FIG. 4, fields for the erase memory map include eMasks and memory regions. Various fields for the erase sector granularities and opcodes include a die byte size, memory sector byte sizes, a die erase opcode, and erase sector opcodes. The erase memory map may include an erase operation to be performed by the target device.

Referring to FIG. 5, FIG. 6, FIG. 7, FIG. 8, FIG. 9, FIG. 10, and FIG. 11, fields for the initialization flow records, pre-erase flow records, post-erase flow records, pre-program flow records, post-program flow records, and post-action flow records may respectively include record type, SPI mode, number of address byes, number of data bytes, number of dummy cycles, command, address, data out, expected data, data mask, and polling timeout. FIG. 11 includes the same post action flow records as FIG. 10. FIG. 11 additionally illustrates an output of the client application 13 after updating the target device 17.

The user selections of the actionable items may allow the user to program the target device 17 for use with the electronic device 14 without modifying the firmware of the electronic device 14. Specific details of the configuration tables and various operations to be performed based on the configuration tables are described below.

### Configuration Tables

In various examples, the configuration tables may include a constant data block and various control flow records. The constant data block may include device information for a target device, such as the target device 17. The device information may include an identification (ID) code value, density, erase sector sizes, command opcodes, a memory map, and the like, without limitation. The device information may occupy a first 160 bytes of the configuration table, as shown in Tables 1-4 below. The control flow records may include command sequences to be performed by the target device. The command sequences may include initialization, pre-erase operations, post-erase operations, pre-program operations, post-program operations, and post action operations, without limitation.

The constant data block may include a header record definition, as shown in Table 1 below. The header record definition may include tool specified information and user specified information. The tool specified information may be determined by the client application 13. The client computing device 12 may establish communication with the target device 17 over the communications network 11. The client application 13 may cause reading of a device ID of the target device 17. Based on the device ID, the client application 13 may determine an SPI mode utilized by the target device 17.

In various examples, the SPI mode may refer to a quad SPI (QSPI) mode or an octal SPI (xSPI) mode. In the QSPI mode, the target device 17 may transfer four (4) bits at one time. In the xSPI mode, the target device 17 may transfer eight (8) bits at one time. The SPI mode may have an associated data transfer rate (DTR). The DTR may be one of a single data rate (SDR) and a double data rate (DDR). The QSPI mode may utilize the SDR. The xSPI mode may utilize the DDR.

TABLE 1
Constant Data Block - Header Record Definition

| Byte | Byte | Number | | |
|---|---|---|---|---|
| Number | Number | of | | |
| Start | End | Bytes | Value | Description |
| 0 | 0 | 1 | E3 | Header Identifier |
| 1 | 1 | 1 | 4A | Header Identifier |
| 2 | 2 | 1 | BD | Header Identifier |
| 3 | 3 | 1 | F9 | Header Identifier |
| 4 | 5 | 2 | User | QSPI Controller |
| | | | Specified | Configuration |
| 6 | 7 | 2 | User | xSPI Controller |
| | | | Specified | Configuration |
| 8 | 15 | 8 | User | User Information |
| | | | Specified | (such as device |
| | | | | name) |
| 16 | 16 | 1 | Tool | Table Major |
| | | | Specified | Version |
| 17 | 17 | 1 | Tool | Table Minor |
| | | | Specified | Version |
| 18 | 18 | 1 | Tool | SPI Mode to be |
| | | | Specified | used (SSPI or |
| | | | | Octal) |
| 19 | 19 | 1 | User | Address Mode |
| | | | Specified | |
| 20 | 20 | 1 | User | Number of Read |
| | | | Specified | IDCode dummy |
| | | | | cycles (SSPI |
| | | | | mode) |
| 21 | 21 | 1 | User | Number of Read |
| | | | Specified | IDCode dummy |
| | | | | cycles (Octal |
| | | | | mode) |
| 22 | 22 | 1 | User | Number of Read |
| | | | Specified | dummy cycles |
| 23 | 23 | 1 | User | Number of SFDP |
| | | | Specified | dummy cycles |
| 24 | 27 | 4 | User | Expected ID Code |
| | | | Specified | |
| 28 | 31 | 4 | User | ID Code Mask |
| | | | Specified | |
| 32 | 33 | 2 | User | Program |
| | | | Specified | Maximum Page |
| | | | | Size |
| 34 | 34 | 1 | User | Page Verify |
| | | | Specified | during |
| | | | | Programming |
| | | | | Flag |
| 35 | 35 | 1 | User | Blank Value |
| | | | Specified | |

The constant data block may include a device density and sector granularity record definition, as shown below in Table 2. The device density and sector granularity record definition may include a total device byte size and various device sector sizes. The total device byte size may be a total device density. The total device size may ensure that the configuration table is a suitable size for the target device 17. The sector sizes may represent a number of bytes that may be stored in various sectors of the target device 17.

TABLE 2
Constant Data Block - Device Density and
Sector Granularity Record Definition

| Byte Number | Byte Number | Number of | | |
|---|---|---|---|---|
| Start | End | Bytes | Value | Description |
| 36 | 39 | 4 | User | Total Device |
| | | | Specified | Byte Size |
| 40 | 43 | 4 | User | Sector Size - |
| | | | Specified | 1 |
| 44 | 47 | 4 | User | Sector Size - |
| | | | Specified | 2 |
| 48 | 51 | 4 | User | Sector Size - |
| | | | Specified | 3 |
| 52 | 55 | 4 | User | Sector Size - |
| | | | Specified | 4 |
| 56 | 59 | 4 | User | Sector Size - |
| | | | Specified | 5 |
| 60 | 63 | 4 | User | Sector Size - |
| | | | Specified | 6 |
| 64 | 67 | 4 | User | Sector Size - |
| | | | Specified | 7 |

The constant data block may include an erase sector memory map, as shown in Table 3 below. The erase sector memory map may include a memory map of the target device 17. The memory map may define sector sizes of the target device 17 to erase. The erase sector memory map may be generated for devices having irregular sector sizes to ensure the proper data is erased. The erase sector memory map may include a set of erase masks (emasks). The emasks indicate types of erase options that are permitted for various sectors of the target device 17. The types of erase options may indicate a memory block size that may be erased for a given sector. The memory block size may be 4 KB, 8 KB, 16 KB, 32 KB, 64 KB, or the entire device, without limitation. The erase sector memory map may additionally include a memory address region for a sector to be erased.

TABLE 3
Constant Data Block - Erase Memory Map Definition

| Byte | Byte | Number | | |
|---|---|---|---|---|
| Number | Number | of | | |
| Start | End | Bytes | Value | Description |
| 68 | 68 | 1 | User Specified | Emask_00 |
| 69 | 69 | 1 | User Specified | Emask_01 |
| 70 | 70 | 1 | User Specified | Emask_02 |
| 71 | 71 | 1 | User Specified | Emask_03 |
| 72 | 72 | 1 | User Specified | Emask_04 |
| 76 | 73 | 1 | User Specified | Emask_05 |
| 74 | 74 | 1 | User Specified | Emask_06 |
| 75 | 75 | 1 | User Specified | Emask_07 |
| 76 | 76 | 1 | User Specified | Emask_08 |
| 77 | 77 | 1 | User Specified | Emask_09 |
| 78 | 78 | 1 | User Specified | Emask_10 |
| 79 | 79 | 1 | User Specified | Emask_11 |
| 80 | 83 | 4 | User Specified | Memory |
| | | | | Address |
| | | | | Region_00 |
| 84 | 87 | 4 | User Specified | Memory |
| | | | | Address |
| | | | | Region_01 |
| 88 | 91 | 4 | User Specified | Memory |
| | | | | Address |
| | | | | Region_02 |
| 92 | 95 | 4 | User Specified | Memory |
| | | | | Address |
| | | | | Region_03 |
| 96 | 99 | 4 | User Specified | Memory |
| | | | | Address |
| | | | | Region_04 |
| 100 | 103 | 4 | User Specified | Memory |
| | | | | Address |
| | | | | Region_05 |
| 104 | 107 | 4 | User Specified | Memory |
| | | | | Address |
| | | | | Region_06 |
| 108 | 111 | 4 | User Specified | Memory |
| | | | | Address |
| | | | | Region_07 |
| 112 | 115 | 4 | User Specified | Memory |
| | | | | Address |
| | | | | Region_08 |
| 116 | 119 | 4 | User Specified | Memory |
| | | | | Address |
| | | | | Region_09 |
| 120 | 123 | 4 | User Specified | Memory |
| | | | | Address |
| | | | | Region_10 |
| 124 | 127 | | | Memory |
| | | 4 | User Specified | Address |
| | | | | Region_11 |

The constant data block may include device opcodes, as shown in Table 4 below. The device opcodes may include vendor or manufacturer specific command opcodes. The command opcodes may be used for erase operations, program operations, and verify operations, without limitation.

TABLE 4
Constant Data Block - Device Opcodes

| Byte | Byte | Number | | |
|---|---|---|---|---|
| Number | Number | of | | |
| Start | End | Bytes | Value | Description |
| 128 | 129 | 2 | User Specified | Die Erase |
| | | | | Command |
| 130 | 131 | 2 | User Specified | Sector Erase 1 |
| | | | | Command |
| 132 | 133 | 2 | User Specified | Sector Erase 2 |
| | | | | Command |
| 134 | 135 | 2 | User Specified | Sector Erase 3 |
| | | | | command |
| 136 | 137 | 2 | User Specified | Sector Erase 4 |
| | | | | Command |
| 138 | 139 | 2 | User Specified | Sector Erase 5 |
| | | | | Command |
| 140 | 141 | 2 | User Specified | Sector Erase 6 |
| | | | | Command |
| 142 | 143 | 2 | User Specified | Sector Erase 7 |
| | | | | Command |
| 144 | 145 | 2 | User Specified | Page Program |
| | | | | Command |
| 146 | 147 | 2 | User Specified | Read Command |
| 148 | 149 | 2 | User Specified | Read ID code |
| | | | | command |
| 150 | 151 | 2 | User Specified | SFDP |
| 152 | 159 | 8 | N/A | N/A |

As described above, the configuration tables may include various flow records. The flow records may include operations to be performed by the target device. The flow records respectively include 28 bytes and have identical formats. The operations include initialization, pre-erase, post-erase, pre-program, post-program, and post-action. The flow records may be parsed by the target device 17 and stored in a dedicated buffer of the target device 17.

TABLE 5
Flow Records Start Index Assignment

| | Start | Max |
|---|---|---|
| | Record | Number of |
| Function | Index | Records |
| Initialization | 0 | 24 |
| Pre-Erase | 24 | 8 |
| Post-Erase | 32 | 8 |
| Pre-Program | 40 | 8 |
| Post-Program | 48 | 8 |
| Post-Action | 56 | 8 |

The flow records may begin by defining a record type. If the record type is 0, the target device 17 will terminate a command sequence and any remaining fields in the flow record are ignored. If the record type is 1, the target device will clock in a command (CMD) opcode and data output from the target device 17 is ignored. If the record type is 2, the target device will clock in a CMD opcode and clock in an address value and data. If the record type is 3, the target device 17 will clock in a CMD opcode, an address value, and data. For the record type of 3, data output from the target device 17 is saved and compared against expected data and a data mask. An error may be generated if there is a mismatch between the data read from the target device 17 and the expected data. If the record type is 4, the target device 17 will behave the same as if the record type was 3 except the operation may be performed in a loop until a maximum time out (poll) value is reached. Record type 4 may be used for polling type operations. The timeout value may correspond to a time delay in microseconds to accommodate worst case timing scenarios for erase or program operations. An error may be generated if there is a mismatch between the data read from the target device 17 and the expected data.

Certain fields may be ignored based on the record type. The ignored fields are indicated below in Table 6.

TABLE 6
Flow Record Format and Field Definitions

| | | | | | Record 2 | | Record 3 |
|---|---|---|---|---|---|---|---|
| 32 | 16 | | Record 0 | Record 1 | (CMD + | Record 3 (CMD + | (CMD + |
| Bits | Bits | Byte | (Terminator) | (CMD only) | Datain) | Datain/out) | Datain/out/poll) |
| 0 | 0 | 0 | Record Type - | Record Type - | Record Type - | Record Type - | Record Type - |
| | | | 0 | 1 | 2 | 3 | 4 |
| | | 1 | SPI Mode | SPI Mode | SPI Mode | SPI Mode | SPI Mode |
| | | | Switch | Switch | Switch | Switch | Switch |
| | | | (ignored) | | | | |
| | 1 | 2 | Number of | Number of | Number of | Number of | Number of |
| | | | Address Bytes | Address Bytes | Address Bytes | Address Bytes | Address Bytes |
| | | | (ignored) | (ignored) | | | |
| | | 3 | Number of | Number of | Number of | Number of Data | Number of |
| | | | Data Bytes | Data Bytes | Data Bytes | Bytes | Data Bytes |
| | | | (ignored) | (ignored) | | | |
| 1 | 2 | 4 | Dummy | Dummy | Dummy | Dummy Cycles | Dummy Cycles |
| | | | Cycles | Cycles | Cycles | | |
| | | | (ignored) | (ignored) | (ignored) | | |
| | | 5 | Delay | Delay | Delay | Delay | Delay |
| | | | (ignored) | | | | |
| | 3 | 6 | CMD | CMD | CMD | CMD | CMD |
| | | 7 | (ignored) | | | | |
| 2 | 4 | 8 | Address | Address | Address | Address | Address |
| | | 9 | (ignored) | (ignored) | | | |
| | 5 | 10 | | | | | |
| | | 11 | | | | | |
| 3 | 6 | 12 | Data In | Data In | Data In | Data In | Data In |
| | | 13 | (ignored) | (ignored) | | | |
| | 7 | 14 | | | | | |
| | | 15 | | | | | |
| 4 | 8 | 16 | Expected Data | Expected Data | Expected Data | Expected Data | Expected Data |
| | | 17 | Out (ignored) | Out (ignored) | Out (ignored) | Out | Out |
| | 9 | 18 | | | | | |
| | | 19 | | | | | |
| 5 | 10 | 20 | Data Mask | Data Mask | Data Mask | Data Mask | Data Mask |
| | | 21 | (ignored) | (ignored) | (ignored) | | |
| | 11 | 22 | | | | | |
| | | 23 | | | | | |
| 6 | 12 | 24 | Max Poll | Max Poll | Max Poll | Max Poll | Max Poll |
| | | 25 | (ignored) | (ignored) | (ignored) | (ignored) | |
| | 13 | 26 | | | | | |
| | | 27 | | | | | |

The various fields may include a record type (described above), an SPI mode switch, a number of address bytes, a number of data bytes, dummy cycles, CMD, address, data in, expected data out, data mask, and maximum poll. The SPI mode switch may cause the firmware code 15 of the electronic device 14 to switch between the QSPI mode or the xSPI mode. The number of address byes indicate a number of valid address bytes to clock into the target device 17. For the QSPI mode, there may be three (3) or four (4) address bytes. For the xSPI mode, there may be four (4) address bytes. The number of data bytes may indicate a number of data bytes to clock into the target device 17. There may be up to four (4) data bytes. For the xSPI mode, the number of data bytes may be a multiple of two (2). The dummy cycles may specific a number of dummy cycles for reading a specified register. The delay may be executed after processing a flow record. The delay may include a first set of bits and a second set of bits. The first set of bits may represent a delay value. The second set of bits may represent a delay multiplier value. The delay multiplier may multiply the delay value by a factor of one (1), ten (10), one hundred (100), or one thousand (1000), without limitation. The register may be specified by the address bytes. The CMD may be a command opcode. The address may be a memory address value. The data in may be data to clock into the target device 17. The expected data out may be expected data to be received from the target device 17. The data mask may indicate invalid bits to mask out when data received from the target device 17 is compared with the expected data. The max poll may indicate the timeout value.

### Exemplary Method

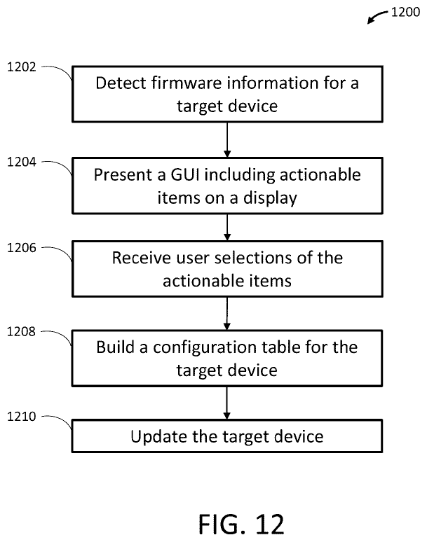

FIG. 12 illustrates an example method for reprogramming a target device. The method may be performed, in part, by a target device, an electronic device, and a client application installed on a client computing device. In various examples, the target device, electronic device, client application, and client computing device may correspond to the target device 17, electronic device 14, client application 13, and client computing device 12 of FIG. 1. The electronic device may include firmware code and an interface, such as the firmware code 15 and the interface 16 of FIG. 1.

At operation 1202, the client application may detect firmware information of the target device. To detect the firmware information, the client computing device may establish communication with the electronic device over a communications network, such as the communication network 11 of FIG. 1. The client application may instruct the electronic device to read a device identifier (ID) of the target device and transmit the device ID to the client computing device. The client application may identify the firmware information based on the device ID. The firmware information may include a data transfer rate (DTR) of the target device. The data transfer rate may include one of a single data rate (SDR) and a double data rate (DDR). The SRD may correspond to a quad SPI (QSPI) mode. The DDR may correspond to an octal SPI (xSPI) mode.

At operation 1204, the client application may present a graphical user interface (GUI) displaying actionable items on a display of the client computing device. In various examples, the display may be the display 27 of FIG. 2. The user may select the actionable items to enter information for reprogramming the target device. User selections of the actionable items may be utilized to build a configuration table for the target device. The configuration table may include a constant data block and a plurality of flow records.

The constant data block may include device information for the target device. The device information may include a memory map, command opcodes, and memory erase sector sizes for the target device. The plurality of flow records may include command sequences to be performed by the target device. The command sequences may include initialization commands, pre-erase commands, post-erase commands, pre-program records, post-program records, and terminate records, without limitations. The device information and the command sequences may be generated based on the user selections of the actionable items and the device ID, as discussed below.

The actionable items may include a plurality of fields. The fields associated with the actionable items may include user specified values for the constant data block and the plurality of flow records. The user specified values for the constant data block are described above with reference to Tables 1-4 and shown in FIG. 3. The user specified values for the constant data block may include a controller configuration, user information, an address mode, a number of read ID code dummy cycles, a number of read dummy cycles, a number of SFDP dummy cycles, an expected ID code, an ID code mask, a programming maximum page size, a page verify during programming flag, a total device byte size, memory sector sizes, emasks, memory address regions, die erase commands, sector erase commands, page program commands, read commands, read ID code commands, and SFDP commands, without limitations.

The user specified values for the plurality of flow records may include a record type and an SPI mode for respective ones of the plurality of flow records. The user specified values for the plurality of flow records are shown in FIGS. 5-11. The plurality of flow records may include respective flow records for initialization operations, pre-erase operations, post-erase operations, pre-program operations, post-program operations, and terminate operations. The user specified values may include a record type and an SPI mode for each of the initialization flow records (FIG. 5), pre-erase flow records (FIG. 6), post-erase flow records (FIG. 7), pre-program flow records (FIG. 8), post-program flow records (FIG. 9), and post action flow records (FIG. 10 and FIG. 11). The record type may be one of the record types described with reference to Table 6. The SPI mode may refer to the SPI mode switch described with reference to Table 6.

The fields may additionally include application specified values. The application specified values may be determined by the client application based on the device ID and the user selections. The application specified values for the constant data block may include header identifiers, table versions, and an SPI mode to be used, without limitation.

At operation 1206, user selections of the actionable items may be received by the client computing device. The user selections may be received by an input device (such as a touchscreen display or peripheral device) of the client computing device. The user selections of the actionable items may include the user specified values for the constant data block and the plurality of flow records, as described above.

At operation 1208, the client application may build a configuration table for the target device. The configuration table may include the user selections of the actionable items and the firmware information of the target device. The configuration table may have a format as described above with reference to Tables 1-7.

At operation 1210, the target device may be updated based on the configuration table. The configuration table may be sent by the client computing device to the electronic device over the communications network. Firmware code of the electronic device may parse the configuration table. The firmware code may ensure that the configuration table is valid for the target device. If the configuration table is invalid or is not present, the electronic device will report an error to the client application. The client application may instruct the electronic device to load data from the configuration table into a buffer before parsing the configuration table.

The configuration table may include an erase memory map for causing the target device to perform an erase operation. The erase operation may cause the target device to erase one or more sectors of memory. The erase memory map may include emask values and associated memory regions. In various examples, each memory region may be assigned with an emask value. The erase memory map may additionally include erase sector granularities and opcodes. The sector granularities may specify a die byte size and byte sizes of various memory sectors of the target device. The erase opcodes may specify erase operations to perform on each sector. The erase operation may be performed based on emask values of an erase sector memory map included in the configuration table, as described above with reference to Table 3. The erase sector memory map may be determined by the client application based on the device ID. The firmware code may identify various erase methods based on the emask values and the memory map. The firmware code may select a largest possible sector size of the target device to erase. Selecting the largest possible sector size may reduce an amount of time utilized for the erase operation. The firmware code may instruct the target device to perform the erase operation. The erase operation may be repeated for respective sectors until a desired number of bytes are erased.

The configuration table may include programming data for causing the target device to perform a programming operation. The client device may instruct the firmware code to load the programming data into the buffer and execute an instruction to pass the programming data to the target device.

The configuration table may include blank check data for instructing the target device to perform a blank check operation. The firmware code may check a blank state for a number of bytes of the target device. The blank check operation may check that a blank state of the target device is specified in the configuration table.

According to various examples of the present disclosure, a non-transitory computer readable medium may have instructions stored thereon that, when executed by one or more processors, cause the one or more processors to perform the following operations: detecting firmware information for a target device; presenting, on a display, a graphical user interface (GUI) including actionable items; receiving user selections for the actionable items; building a configuration table for the target device based on the user selections; and updating the target device based on the configuration table and the firmware information.

In combination with any of the above examples, the instructions, when executed by the one or more processors, may cause the one or more processors to determine a data transfer rate of the target device based on the firmware information.

In combination with any of the above examples, the firmware information may include an identifier (ID) of the target device.

In combination with any of the above examples, the data transfer rate may be one of a single data rate (SDR) and a double data rate (DDR).

In combination with any of the above examples, the configuration table may include device information for the target device and command sequences to be performed by the target device.

In combination with any of the above examples, the device information may include a memory map, command opcodes, and memory erase sector sizes for the target device.

In combination with any of the above examples, the command sequences may include device initialization commands, erase commands, and programming commands.

In combination with any of the above examples, at least a portion of the device information and the command sequences may be generated based on the user selections of the actionable items.

According to various examples of the present disclosure, a computer implemented method is provided. Firmware information associated with a target device may be detected. A GUI including actionable items may be presented on a display. User selections for the actionable items may be received. A configuration table for the target device may be built based on the user selections. The target device may be updated based on the configuration table and the firmware information.

In combination with any of the above examples, a data transfer rate of the target device may be determined based on the firmware information. The firmware information may include an ID of the target device.

In combination with any of the above examples, the data transfer rate may be one of an SDR and a DDR.

In combination with any of the above examples, the configuration table may include device information for the target device and command sequences to be performed by the target device.

In combination with any of the above examples, the device information may include a memory map, command opcodes, and memory erase sector sizes for the target device.

In combination with any of the above examples, the command sequences may include device initialization commands, erase commands, and programming commands.

In combination with any of the above examples, at least a portion of the device information and the command sequences may be generated based on the user selections of the According to various examples of the present disclosure, a system is provided. The system includes a target device and one or more computing devices. The one or more computing devices may include a memory and one or more processors. The memory may include instructions stored thereon that, when executed by the one or more processors, cause the one or more processors to perform the following operations: detecting firmware information for the target device; presenting, on a display, a graphical user interface (GUI) including actionable items; receiving user selections for the actionable items; building a configuration table for the target device based on the user selections; and updating the target device based on the configuration table and the firmware information.

In combination with any of the above examples, the firmware information may include an ID of the target device and an indication of a data transfer rate of the target device.

In combination with any of the above examples, the data transfer rate may be one of an SDR and a DDR.

In combination with any of the above examples, the configuration table may include device information for the target device and command sequences to be performed by the target device.

In combination with any of the above examples, the device information may include a memory map, command opcodes, and memory erase sector sizes for the target device. The command sequences may include device initialization commands, erase commands, and programming commands. At least a portion of the device information and the command sequences may be generated based on the user selections of the actionable items.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the disclosure as hereinafter claimed along with their legal equivalents. In addition, features from one example may be combined with features of another example while still being encompassed within the scope of the disclosure as contemplated by the inventors.

What is claimed is:

1. A non-transitory computer readable medium having instructions stored thereon that, when executed by one or more processors, cause the one or more processors to:
detect firmware information for a target device;
present, on a display, a graphical user interface (GUI), said GUI including actionable items;
receive user selections for the actionable items;
build a configuration table for the target device based on the user selections; and
update the target device based on the configuration table and the firmware information.

2. The non-transitory computer readable medium of claim 1, wherein the instructions, when executed by the one or more processors, cause the one or more processors to determine a data transfer rate of the target device based on the firmware information.

3. The non-transitory computer readable medium of claim 2, wherein the firmware information includes an identifier (ID) of the target device.

4. The non-transitory computer readable medium of claim 2, wherein the data transfer rate is one of a single data rate (SDR) and a double data rate (DDR).

5. The non-transitory computer readable medium of claim 1, wherein said configuration table includes device information for the target device and command sequences to be performed by the target device.

6. The non-transitory computer readable medium of claim 5, wherein said device information includes a memory map, command opcodes, and memory erase sector sizes for the target device.

7. The non-transitory computer readable medium of claim 5, wherein said command sequences include device initialization commands, erase commands, and programming commands.

8. The non-transitory computer readable medium of claim 5, wherein at least a portion of the device information and the command sequences are generated based on the user selections of the actionable items.

9. A computer-implemented method comprising:
detecting firmware information associated a target device;
presenting, on a display, a graphical user interface (GUI), said GUI including actionable items;
receiving user selections for the actionable items;
building a configuration table for the target device based on the user selections; and
updating the target device based on the configuration table and the firmware information.

10. The computer-implemented method of claim 9, comprising determining a data transfer rate of the target device based on the firmware information, said firmware information including an identifier (ID) of the target device.

11. The computer-implemented method of claim 10, wherein the data transfer rate is one of a single data rate (SDR) and a double data rate (DDR).

12. The computer-implemented method of claim 9, wherein said configuration table includes device information of the target device and command sequences to be performed by the target device.

13. The computer-implemented method of claim 12, wherein said device information includes a memory map, command opcodes, and memory erase sector sizes for the target device.

14. The computer-implemented method of claim 12, wherein said command sequences include device initialization commands, erase commands, and programming commands.

15. The computer-implemented method of claim 12, wherein at least a portion of the device information and the command sequences are generated based on the user selections of the actionable items.

16. A system comprising:
a target device; and
one or more computing devices including a memory and one or more processors, said memory including instructions stored thereon that, when executed by the one or more processors, cause the one or more processors to:
detect firmware information associated the target device;
present, on a display, a graphical user interface (GUI) including actionable items;
receive user selections of the actionable items;
build a configuration table for the target device based on the user selections; and
update the target device based on the configuration table and the firmware information.

17. The system of claim 16, wherein the firmware information includes an identifier (ID) of the target device and an indication of a data transfer rate of the target device.

18. The computer-implemented method of claim 17, wherein the data transfer rate is one of a single data rate (SDR) and a double data rate (DDR).

19. The system of claim 16, wherein said configuration table includes device information of the target device and command sequences to be performed by the target device.

20. The system of claim 19,
wherein said device information includes a memory map, command opcodes, and memory erase sector sizes of the target device,
wherein said command sequences include device initialization commands, erase commands, and programming commands,
wherein at least a portion of the device information and the command sequences are generated based on the user selections of the actionable items.
